(19) United States
(12) Patent Application Publication
(10) Pub. No.: US 2011/0219959 A1
(43) Pub. Date: Sep. 15, 2011

(54) CITRUS JUICE AND MEASURE

(75) Inventor: Lawrence Hauser, Auburn, WA (US)

(73) Assignee: PROGRESSIVE INTERNATIONAL CORPORATION, Kent, WA (US)

(21) Appl. No.: 13/047,550

(22) Filed: Mar. 14, 2011

Related U.S. Application Data
(60) Provisional application No. 61/313,345, filed on Mar. 12, 2010.

(51) Int. Cl. A23N 1/02; G01F 23/00

(52) U.S. Cl. 99/508

(57) ABSTRACT

A juicer and measurer includes a lower container having a circumference that is preferably small enough to be grasped and held by a single hand. An upper rim region supports a reamer atop a funnel that flares outwardly to collect juice and funnel it into the container. In an exemplary version, the flared upper rim includes at least one region that is configured to serve as a spout so that the juice can be poured from the container more readily.

### PRIORITY CLAIM

This application claims the benefit of U.S. Provisional Application Ser. No. 61/313,345 filed Mar. 12, 2010, the contents of which are incorporated by reference.

### BACKGROUND OF THE INVENTION

Juicers for smaller citrus fruits such as lemons and limes can be difficult to use. For the most part, they include an upper reamer supported by a shallow container for collecting the juice, with the container being configured in a way that is difficult to manage. In some cases the container includes a flange or a handle, which provides some degree of improvement over this long felt need, but the shallow nature of the container and the typically wide diameter of the container can still make it difficult to grasp. Likewise, the size of the container and reamer hinder the ability to accurately measure the amount of juice obtained from the fruit.

### SUMMARY OF THE INVENTION

The preferred juicer and measurer includes a lower container that is configured such that it can be more readily hand-held in order to use it. Thus, the circumference of the container is preferably small enough to be grasped and held by a single hand.

Preferably, the container includes an upper rim region that flares outwardly to collect juice and funnel it into the container. In an exemplary version, the flared upper rim includes at least one region that is configured to serve as a spout so that the juice can be poured from the container more readily.

These and other examples of the invention will be described in further detail below.

### BRIEF DESCRIPTION OF THE DRAWINGS

The preferred versions of the invention are described below and illustrated in the following figures.

FIG. 1 is a perspective view of a preferred version of a juice and measure.

FIG. 2 is a front view of a preferred version of a juice and measure.

FIG. 3 is an exploded view of the version illustrated in FIG. 1.

FIG. 4 is a perspective view of the preferred reamer as illustrated in FIG. 1.

### DETAILED DESCRIPTION OF THE PREFERRED EMBODIMENT

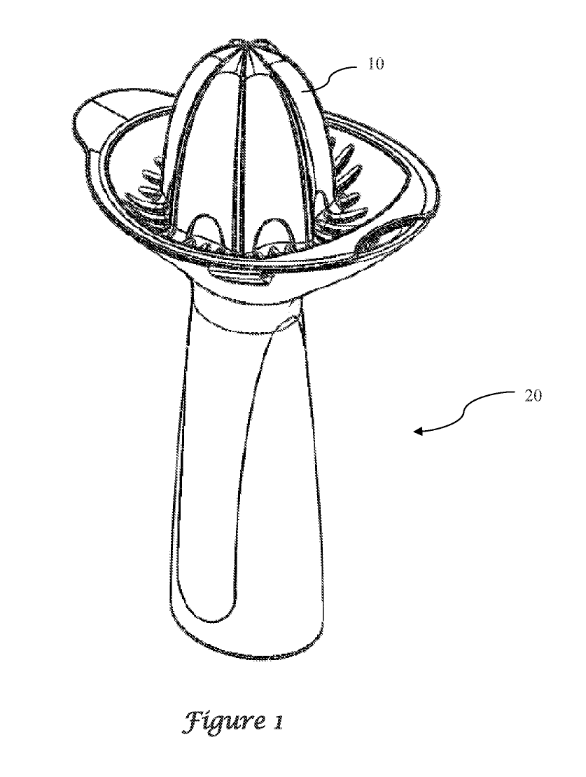

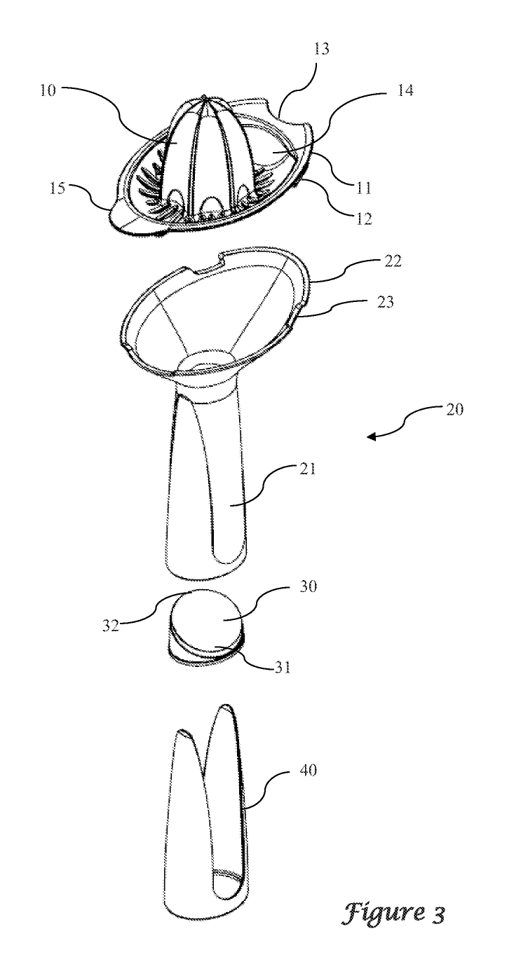

An exemplary juicer with measurer is illustrated in the drawings as described above. In general, as shown in the perspective view of FIG. 1, the juicer includes an upper reamer 10 that is supported by a lower container 20. The container may include an insert 30 (best seen in the exploded view of FIG. 3) forming a floor of the container, and may optionally include an external casing 40 to provide an improved grip.

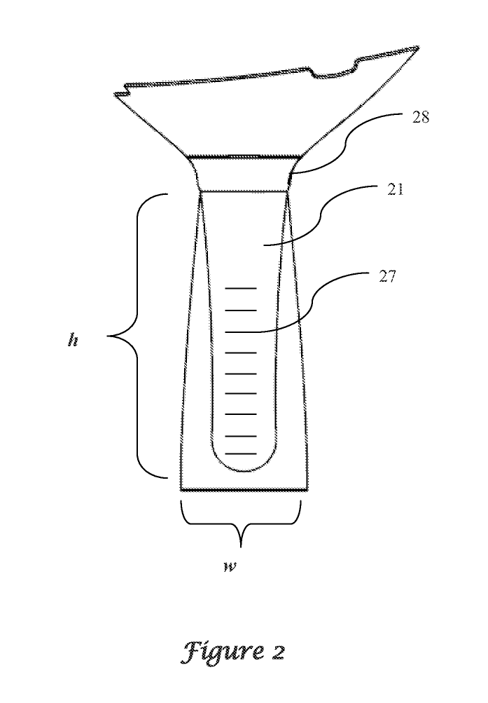

The container preferably includes a main container body 21 having a lower portion and an upper portion. Preferably the main container body is formed from a clear material to enable it to be used as a measuring container, with volumetric markings 27 (best seen in FIG. 2) spaced apart along a sidewall that extends from the lower portion to the upper portion. In the version as shown, the main container body is tapered such that it is wider at the lower portion and narrower at the upper portion. In other versions, however, it may be generally uniform in cross section, hourglass shaped, or otherwise configured.

The container body includes a circumference about the perimeter defined by the upwardly extending sidewalls, and in the preferred version the circumference in at least one location between the lower portion and the upper portion is small enough to be readily grasped by a single hand. Thus, preferably the circumference is less than about 7 inches, and more preferably it is less than about 6 inches or less than about 5 inches. As desired, a portion of the container may be even smaller, for example forming a narrow neck at the upper portion that may be about 4 inches in diameter or even smaller. Likewise, the ideal configuration is one in which the smallest circumference location is at the top 28 of the main container body, with the circumference at the lower portion being larger.

As a container that is preferably configured such that it can be grasped by a single hand yet still provide a reasonable internal volume, the height h of the container body is greater than the diameter or width w of the container body. In a preferred version, the height is approximately twice the width. In other versions the ratio may be varied, such as a height that is about 1½ times the width or that is about 3 times the width.

At the top of the upper portion of the main container body, the upper portion of the container flares outwardly to form a funnel 22. In the exemplary version, the container forms a narrowed neck where the base of the funnel joins the upper portion 28 of the container body. The funnel is configured to have a relatively large diameter at a rim as compared to the main container body, tapering as it progresses from the rim of the funnel to the neck positioned at the transition from the funnel to the main container body. In the preferred version as shown, the funnel and main container body are integrally formed from plastic or other suitable materials.

A base cap 30 is configured to be secured to the base of the main container body, at the lower portion of the container. The base cap is shaped to fit within the hollow interior cavity of the main container body, which in the preferred version is generally circular in cross section. Thus, at its lower end, the base cap is also circular in cross section. The upper end of the base cap is generally planar and inclined at an angle formed with respect to the plane of the lower end of the base cap. At a first position along the base cap the upper end is relatively close to the lower end, while at a position diametrically opposed to the first position the upper end of the base cap is significantly higher than the lower end.

When the base cap is positioned within the main container body, it forms a floor for the interior space defined by the main container body. This floor of the interior space is inclined, with a lower side 31 and a higher side 32. The lower side is positioned adjacent the sidewall having the volumetric markings 27, with the higher side being positioned diametrically opposite. This inclined floor allows the container to be able to measure relatively small volumes of juice, such as one or more tablespoons. Thus, the volumetric markings are preferably spaced as desired to allow for measurement of small volumes. In an exemplary version, the container is configured with volumetric markings of 1, 2, 3, and 4 tablespoons, with a total volume of about ¼ cup and an accompanying volumetric marking

While a base cap is used to configure the floor in the exemplary version of the invention, the main container body may alternatively be constructed as a single integral unit, incorporating an inclined floor into the integral device. Likewise, in other versions of the invention the floor may be substantially flat or perpendicular to a central axis extending vertically through the main body, rather than being inclined as illustrated.

The external casing 40 surrounds a portion of the main container body, encasing the base cap as well. In the exemplary version, the casing is provided along a portion of the upwardly extending sidewalls while leaving a portion of the sidewalls exposed. When the main container body is formed from a clear material while the casing is formed from an opaque material, this arrangement allows a user to see the juice within the container through the part of the main container body that is not covered by the external casing. Thus, in a preferred version the volumetric markings are placed along the sidewalls along the uncovered portion of the container body.

The reamer 10 is configured to be attached to the funnel so that a portion of a citrus fruit can be juiced by the reamer and the juice may be collected by the funnel and directed into the container. The reamer is carried by a strainer body 11, and preferably the reamer is integrally formed with the strainer body. The strainer body includes one or more perforations 18 that are sized to allow juice to pass through while retaining seeds, membranes, or other larger solid matter.

The reamer may be secured to the funnel in any manner, and in the preferred version the strainer body includes a plurality of clips 12 that engage a portion of the rim of the funnel. As shown, the strainer body includes three downwardly-depending clips that are positioned to be received within three corresponding cutouts 23 about the rim of the funnel, with the clips frictionally engaging a portion of the rim. Accordingly, the strainer body is removably secured to the funnel in the illustrated version.

The upper rim of the funnel is preferably generally formed in the shape of a spout along at least one location, for example by forming the funnel such that it is somewhat oval in shape or otherwise longer along one diameter than along an orthogonal diameter. Alternatively, it may be formed with a more particularly formed spout such as in a measuring cup. Once juice is funneled into the container by forcing the citrus fruit against the reamer, the juice may be poured out again by tipping the container and controlling the flow by directing the spout in a desired manner.

The juice may be poured from the container with the strainer removed, and the removal of the strainer may allow for the tidiest pouring when there are seeds, membranes, or significant pulp trapped in the strainer. A tab 15 is formed along a perimeter of the strainer to allow a user to grasp the strainer to remove it from the funnel.

Alternatively, the strainer may be left in place for pouring. In order to more readily facilitate pouring with the strainer connected to the funnel, the strainer includes a recessed region 13 formed to be adjacent the spout of the funnel when the strainer is in place and clipped to the funnel. The strainer also includes a domed or otherwise raised portion 14 positioned adjacent the recessed region to provide greater clearance for juice to flow from the funnel beneath the strainer. Thus, while the main strainer body is generally concave around the periphery of the reamer, the domed portion 14 is raised and convex in the region adjacent the recessed or cutout region 13 to allow a passageway for juice to flow out of the funnel.

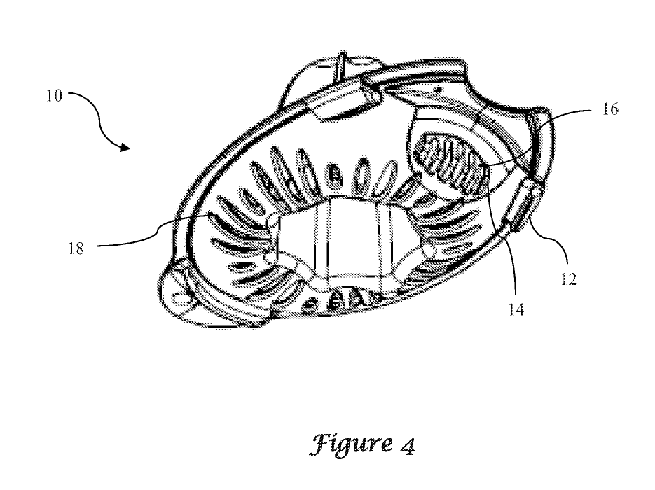

In one version of the invention the strainer includes a filter for separating pulp from the juice as it is poured from the container. This is implemented in the version as shown in FIG. 4 by providing a plurality of fingers 16 depending downwardly from the lower side of the dome 14, the fingers being separated by relatively narrow channels. The fingers have a length such that they extend from the raised dome at one end to the funnel at the other end. In this configuration, the fingers constrict the flow of the juice from the container through the recessed region and out the spout. The channels are sized to allow juice to pass through but to retain the pulp. Thus, by pouring the juice with the strainer in place atop the funnel, the resulting juice is pulp-free. In alternate versions, a mesh or other grid strainer may be used in place of the fingers with narrow channels.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A juice and measure device, comprising:
a container body defining an internal volume, the container body having a height and a width, the height being greater than the width;
a funnel supported by an upper end of the container body; and
a reamer supported atop the funnel, the reamer being secured to a strainer body defining at least one fluid pathway through the strainer body and into the container body.

2. The juice and measure of claim 1, wherein the funnel is integrally formed with the container body.

3. The juice and measure of claim 1, wherein the funnel is permanently secured to the container body.

4. The juice and measure of claim 1, wherein the strainer body is formed in a concave shape about a base of the reamer.

5. The juice and measure of claim 4, wherein the strainer body defines a plurality of fluid pathways through the strainer body.

6. The juice and measure of claim 5, wherein the strainer body further comprises a perimeter, a majority of the perimeter being adjacent a rim of the funnel, and further wherein the strainer body comprises a recessed region along a portion of the perimeter, the recessed region defining a larger fluid pathway between the perimeter of the strainer body and the funnel.

7. The juice and measure of claim 6, wherein the strainer body further comprises a lower surface facing away from the reamer, the lower surface comprising a plurality of adjacent fingers in the vicinity of the recessed region, the plurality of fingers defining a plurality of channels.

8. The juice and measure of claim 7, wherein each of the plurality of fingers extends from the lower surface of the strainer body to an upper surface of the funnel.

9. The juice and measure of claim 1, wherein the container body further comprises an interior base, the interior base having a surface inclined with respect to a central axis extending vertically along the height of the container body.

10. The juice and measure of claim 9, wherein the container body further comprises a plurality of volumetric markings on a surface of the container body, each of the volumetric markings corresponding to a volume within the container body.

11. The juice and measure of claim 10, wherein the volumetric markings are positioned along a first side of the container body, the interior base further having a lower side and a higher side, the lower side being positioned at the first side of the container body and the higher side being positioned diametrically opposite the first side.

12. The juice and measure of claim 11, wherein the height is between 1.5 and 3 times greater than the width.

13. The juice and measure of claim 12, wherein a largest diameter of the container body is less than seven inches.

14. The juice and measure of claim 12, wherein the height is more than two times greater than the width.

15. The juice and measure of claim 6, wherein the strainer body further comprises a lower surface facing away from the reamer, the lower surface comprising a means for straining fluid, the means for straining fluid being positioned adjacent the rim of the funnel.
